(19) United States
(12) Patent Application Publication
(10) Pub. No.: US 2018/0180224 A1
(43) Pub. Date: Jun. 28, 2018

(54) SYSTEM AND METHOD FOR GAS MANAGEMENT

(71) Applicant: PRINGLE BELESKI AND ASSOCIATES LIMITED, Porirua (NZ)

(72) Inventors: John Stafford PRINGLE, Darfield (NZ); Robert William SILCOCK, Lincoln (NZ)

(73) Assignee: PRINGLE BELESKI AND ASSOCIATES LIMITED, Porirua (NZ)

(21) Appl. No.: 15/737,733

(22) PCT Filed: May 17, 2016
(86) PCT No.: PCT/NZ2016/050078

§ 371 Date: Dec. 18, 2017

(30) Foreign Application Priority Data
Jun. 18, 2015 (NZ) 709254

(51) Int. Cl. F17C 13/02; G01N 11/02; G01M 3/32

(52) U.S. Cl. CPC F17C 13/02; G01N 11/02; G01M 3/32; F17C 2223/0123; F17C 2250/07; F17C 2250/0447; F17C 2250/0473; F17C 2221/01; F17C 2260/044; F17C 2250/043

(57) ABSTRACT

The invention relates to a system and method for managing gas within one or more receptacles in one or more locations. The system and method comprises a control system that is configured to analyse data relating to gas transfer operations to identify gas leaks and to calculate the rate of any gas leaks identified.

### FIELD OF THE INVENTION

The invention relates to a system and method for managing a gas, such as sulfur hexafluoride gas (SF₆).

### BACKGROUND TO THE INVENTION

SF₆ is a gas commonly used in the electrical industry as an insulator for high voltage equipment, such as circuit breakers, because of its high dielectric strength. Pure SF₆ is odourless, tasteless, non-toxic, non-corrosive, non-flammable, and chemically inert at ambient temperature. It also has a particularly high potential to adversely affect global warming. This potential is approximately 23,000 greater than that of carbon dioxide (CO₂). Because of the risk that SF₆ gas presents to global warming, New Zealand requires reports on all emissions from large users of SF₆. The report submitted is converted into carbon units in which one unit is equivalent to approximately 45 grams of SF₆. To achieve the accuracy of reporting to a single carbon unit the SF₆ gas must be measured in increments of 0.050 KG.

Regulations for reporting synthetic greenhouse gas emissions under the New Zealand Emissions Trading Scheme came into force from 1 Jan. 2011. Persons who use SF₆ in operating electrical equipment, and who are above the prescribed threshold of 1,000 kg are required to comply with these Regulations. The Regulations require these persons to collect certain data to calculate and report on greenhouse gas emissions associated with certain activities from 1 Jan. 2013. A report needs to be submitted each 12 months for the gas emissions for the year. These persons must also retain sufficient records to enable the New Zealand Environmental Protection Authority to verify the emissions reported in their emissions return. Records must be retained for a period of at least seven years after the end of the year to which they relate, including any records related to removal activities. It is therefore important to provide a system that measures greenhouse gas transactions and that provides substantially accurate traceability in the gas transaction process.

It is an object of the invention to provide a system and/or method for managing gas that goes at least some way toward overcoming the disadvantages of the prior art or that at least provides the public with a useful choice.

### SUMMARY OF THE INVENTION

In one aspect, the invention provides a gas management system comprising: at least one gas measurement system comprising a flow meter to measure gas flow into and out of at least one receptacle to provide gas transaction data; and a control system configured to receive the gas transaction data, wherein the control system is also configured to analyse the gas transaction data to identify a gas leak from the at least one receptacle; and to determine the rate of the gas leak, when identified.

Preferably, the control system is configured to forecast the time and date of when a leaking receptacle will reach the lock out state.

The control system may comprise or be connected to an alarm that provides an alert when the control system forecasts a lockout state.

Preferably, the control system comprises a database that records the gas transaction data for each gas receptacle. Optionally, the database records: the make, model, serial number, function, rating, nameplate information, installation date, and/or location of each gas receptacle monitored by the gas management system. Optionally, the database records information identifying the operator handling each gas receptacle and the dates on which each gas receptacle was handled by that operator. Optionally, the database records the owner of one or more gas receptacles monitored by the gas management system.

Preferably, the control system is configured to calculate the accurate volume of a receptacle.

In one form, the system comprises a dew point meter to measure the moisture content of the gas and wherein the gas transaction data includes data relating to the moisture content of the gas.

Preferably, the gas measurement system comprises a user interface through which an operator may input any one or more of the following:

a. an operator ID;

b. a receptacle ID;

c. any other details identifying the operator and/or receptacle being handled.

Optionally, the control system is configured to identify the types of gas receptacles for which a predetermined number of gas leaks have occurred within a predetermined time period and to provide an equipment alert indicating that these types of receptacles may be prone to gas leaks.

Preferably, the control system is configured to identify any operators handling gas receptacles for which a predetermined number of gas leaks have occurred within a predetermined time period and to provide an operator alert indicating that this/these operator(s) may need further gas handling training.

In one form, the gas measurement system comprises a fixed or removable storage medium for storing gas transaction data. Preferably, the gas measurement system is configured to receive a USB stick. Optionally, the gas measurement system comprises a fixed storage medium and a transmitter for transmitting gas transaction data to the control system or to an external storage device.

In another aspect, the invention provides a method of managing gas in one or more receptacles; the method comprising: measuring the mass of gas into at least one receptacle and subsequently measuring the mass of gas out of the at least one receptacle with a gas flow meter; providing the measurements to a control system as gas transaction data; receiving and analyzing the gas transaction data in the control system to identify if a gas leak has occurred from the at least one receptacle; and calculating the leak rate of gas from the at least one receptacle and determining when the receptacle will be emptied of gas if the leak continues.

Preferably, the gas transaction data is stored on a storage medium connected to the gas measurement system before the gas transaction data is communicated to the control system.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

Preferred embodiments of the invention will be described by way of example only and with reference to the drawings, in which:

FIG. 1 is a diagram of one form of gas management system according to the invention.

### DETAILED DESCRIPTION OF PREFERRED EMBODIMENTS

The invention relates to a gas management system and method that monitors gas movements to identify gas leaks.

The system and method may be used to monitor any suitable gas and is particularly suitable for use with SF₆ gas and other greenhouse gases that may negatively contribute to global warming, such as many different types of refrigeration gases.

The system and method of the invention are configured to monitor the volume of gas transferred into or out of a gas receptacle, such as a gas cylinder or circuit breaker, during a gas transfer operation. Each gas transfer operation is referred to herein as a transaction.

The gas management system comprises at least one gas measurement system, at least one gas receptacle, a control system, and a control system user interface.

Aspects of the systems and methods described below may be operable on any type of computer system or computing device, including, but not limited to, a desktop, laptop, notebook, tablet, or mobile electronic device.

### Gas Measurement System

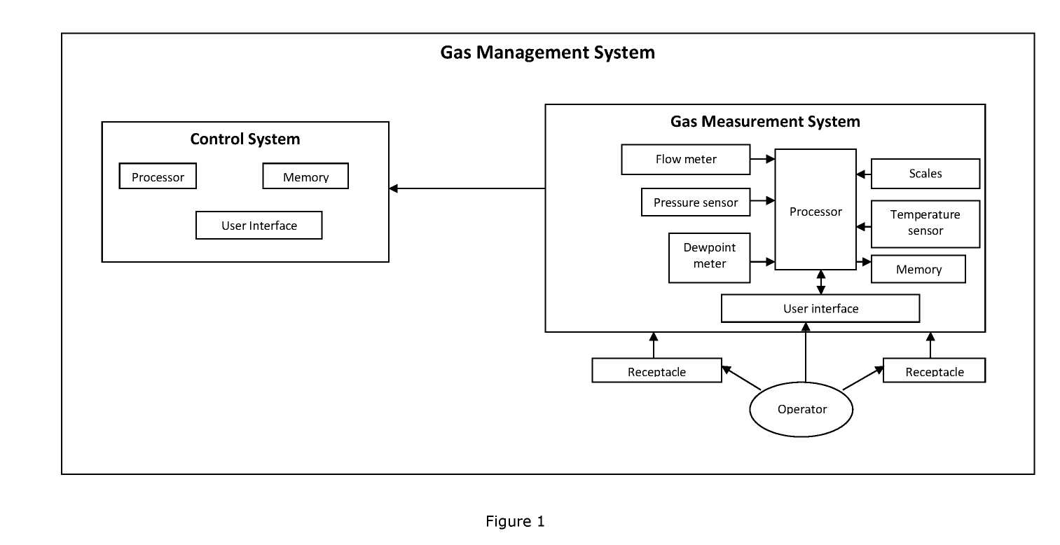

The at least one gas measurement system comprises at least one gas flow meter configured to measure the mass of gas added to a receptacle (gas input) during filling and gas top ups. The flow meter is also configured to measure the mass of gas being removed from the receptacle (gas output) during degassing or filtration at a later date. The gas flow measurements allow the volume of gas passing into or out of a receptacle at each operation to be calculated, either by the gas measurement system or the control system. In one form, as shown in FIG. 1, the gas measurement system may also comprise sensors to measure the temperature, the start pressure of a gas receptacle (before a gas input or output operation), and the end pressure of the receptacle (after the gas input or output operation). The temperature and pressure of a gas can affect the volume calculations if the volume is determined from the gas flow rate alone. Therefore, in one form, the gas management system is configured to make adjustments for variations in temperature and pressure between the time of gas input and the time of gas output, so that a substantially accurate gas input/output volume can be calculated.

In one form, the gas measurement system also comprises gas removal equipment. Alternatively, gas removal equipment may be connected to the gas measurement system during operation.

In one form, the gas measurement system may comprise a data processor that is programmed to receive the mass flow, temperature and pressure readings of the gas for each input and output transaction and to calculate the gas volume for each transaction. The gas volume measurement is then provided to the control system as transaction data. Alternatively, the control system may be programmed to receive transaction data that comprise the mass flow, temperature, and pressure readings of the gas and to calculate the gas volume itself. For example, in one scenario of use, the gas flow meter is connected to a receptacle for a gas transaction to take place. The flow meter measures the ambient temperature and the start pressure of the gas in the receptacle. Gas is then transferred into or out of the receptacle, as the case may be. The flow meter measures the mass of the gas that passes through it. Optionally, the flow meter is configured to also measure the temperature and pressure of the gas passing through the flow meter. Once the gas movement ceases, the flow meter may again measure the ambient temperature and end pressure of the gas in the receptacle. The measurements may be recorded by the gas measurement system or transmitted or otherwise communicated directly to the control system or to an external device. The measurements may be used to calculate the volume and/or density of the gas transferred. In one form, this calculation may be made by the gas management system or, in another form, it may be made by the control system. The volume/density measurements may be stored and used for further calculations to determine how much gas a receptacle has gained or lost when a gas volume/density change is detected by the system. The gas volume/density change can be the result of: a gain from topping up, a loss from leaks to atmosphere, a loss from testing and handling the gas, or a loss from removing the gas for any other reason.

In some scenarios, such as when all gas is removed from a receptacle, the gas measurement system or the control system may be configured to calculate the accurate volume of the receptacle by using the start and end measurements and the measured mass of gas transferred to or from the receptacle. The volume measurement may then later be used to calculate the mass of gas to be added to or removed from that receptacle to achieve a desired pressure at a certain temperature. In this way, the receptacle volume measurements may be used to provide accurate values of gas contained within particular receptacles.

As shown in FIG. 1, the gas measurement system may also comprise a sensor in the form of a dew point meter to measure the moisture content of the gas being handled. The transaction measurements communicated to the control system may also comprise the dew point meter measurements. Additionally or alternatively, the dew point meter readings may be displayed on a user interface for the gas measurement system. The inclusion of a dew point meter may assist the gas management system to identify any gas receptacles or types of receptacles that are prone to condensation. Typically, any condensation within a gas receptacle reduces the quality of the gas and is best avoided.

The at least one gas measurement system may also comprise a user interface that may display information for use by an operator. For example, the gas measurement system may be configured to determine the amount of top up gas needed to bring a gas receptacle to the desired gas density and to display this amount on a display screen of the user interface.

In one form, the user interface is configured to enable an operator to enter information that may be linked to the gas flow measurements and other transaction data for a gas transaction (and optionally linked also to the gas pressure and temperature measurements) once the operator begins using the gas flow meter. The user interface may be a display screen, such as a touch screen, a graphical user interface, or any other suitable interface for receiving information from the operator and linking that information to the gas transaction data.

For example, through the user interface, an operator may enter an operator ID (identifier) to identify himself/herself. The operator ID may be: the operator's name; the approved filler number of the operator; an individual identification number; a passcode; a fingerprint of the operator; or any other suitable method of identifying the operator. The operator ID may also include information identifying the operator's employer. For example, the user interface may require a two-step process in which the operator enters a personal identification code and then enters an employer identification code. In one form, the operator ID may be automatically linked to the name of the employer. For example, the personal identification code may include a portion that identifies the operator's employer. Optionally, the gas measurement system is configured so that it defaults to a locked state and cannot be used unless a recognised operator ID is entered through the user interface.

Through the user interface, the operator may also enter a receptacle ID to identify the particular receptacle(s) on which the gas transfer operation will take place. For example, the operator may enter a cylinder code, through the user interface. Alternatively, the gas flow meter may include a receptacle ID reader, such as an optical reader, that reads a receptacle ID, such as a bar code, placed on the receptacle. The receptacle ID may include information identifying the make, model, serial number, function, rating, nameplate information, installation date, of the receptacle and/or the owner of the receptacle, or this information may be entered into the user interface separately by the operator.

The gas measurement system may communicate the transaction data immediately to the control system, or the measurement system may comprise a storage medium for storing gas transaction data, which is periodically communicated to the control system. In one form, the storage medium may be a fixed memory that is integral with the gas measurement system and that is configured to communicate transaction data to the control system, or it may be a removable memory. For example, in one form, the gas measurement system comprises a USB port for receiving a removable USB stick on which gas measurement data may be stored. The gas measurement data on the USB stick may later be uploaded to the control system by any suitable method.

The gas measurement system may also comprise a real time electronic clock. In one form, the clock is configured to record the real time at which the measurement system receives the operator ID through the user interface and to store that time as an operator ID time stamp in memory. The time stamp is linked with the operator ID to form operator identifier data. In one form, the electronic clock may be configured to record the real time at which the gas flow meter is used during a gas transaction. The clock may be configured to record only the start time of the transaction or it may be configured to record the start and finish times. Again, each real time entry may be recorded in memory as a transaction time stamp that is linked with the transaction measurements. Optionally, the real time clock may also record the real time at which the receptacle ID is received by the gas measurement system. Each entry is recorded in the memory as a receptacle ID time stamp and is linked to the receptacle ID. The operator ID, operator ID time stamp, receptacle ID, receptacle ID time stamp, transaction measurements, and transaction time stamp(s) for each gas transaction may be linked and communicated to the control system as gas transaction data.

The transaction data may be communicated from the gas measurement system to the control system by any suitable method.

In one form, the gas measurement system comprises a transmitter for wirelessly transmitting the transaction data to the control system or to an external storage device from which the transaction data will later be communicated to the control system by any suitable method, such as via a serial interface.

In one form, the gas measurement system is also configured to receive transaction data from the control system, such as when the control system is programmed to receive gas flow measurements, temperature measurements, and pressure measurements to calculate the volume of gas added to or removed from a receptacle during a gas transfer operation.

Optionally, the gas measurement system is in the form of a gas flow meter that comprises a storage medium and optionally comprises a temperature sensor, pressure sensor, dew point sensor, transmitter, and/or processor.

Control System

The control system is configured to receive transaction data derived from one or more gas measurement systems and to analyse that data to identify if gas has likely leaked from a receptacle and to calculate the rate of the gas leak, if a leak is identified.

In one form, the control system comprises a processor for analysing and processing transaction data, a storage medium for storing gas transaction data, and a user interface for displaying transaction data, alerts, and any other system management data to assist a user to monitor gas movements.

The control system processor is optionally programmed to calculate the volume and/or density of gas added to or removed from a receptacle during a gas transaction, by receiving mass flow, temperature and pressure readings of gas for each gas transaction and calculating the volume/density of gas transacted based on those readings.

The processor may be programmed to analyse gas transaction data from one or more gas flow meters by comparing the volume/density of gas removed from a gas receptacle with the recorded volume/density of gas that was last added to the receptacle and that is stored in the storage medium. If the volume/density of gas removed from a receptacle is less than the volume/density of gas that was originally added to the receptacle, the processor may indicate that a gas leak has occurred. Similarly, the processor may indicate that a leak has occurred when a gas receptacle requires a gas top up to reach its preferred volume/density. If the processor identifies a gas leak, the control system may generate a gas leak alert. The processor may also be programmed to calculate the rate of the gas leak. Additionally, the processor may be programmed to calculate the date and time at which a gas receptacle with an identified leak, such as a circuit breaker, will be emptied of gas. When a receptacle is emptied of sufficient gas, the receptacle is considered to be in a lock out state.

The control system may be configured to forecast when a receptacle will reach the lock out state by identifying that a predetermined amount of gas has leaked from the receptacle and/or by identifying that a predetermined amount of gas remains in the receptacle or within gas removal equipment that may be used with the gas measurement system. For example, the control system may calculate the expected time of a lock out state by using the formula:

$$\frac{d m}{dt}$$

where m is mass and t is time.

Optionally, the control system is configured to generate an initial alarm prior to the forecast lock out state and to generate a further alarm if the lock out state is reached. Where a receptacle, such as a circuit breaker, is in the lock out state, it may be unsafe to use.

In one form, the control system is configured to generate an alert when a circuit breaker is in the lock out state.

In another form, the control system is configured to generate an alert when equipment replacement or repair may be required. This alert may be generated, for example, when the control system identifies that a certain receptacle or type of receptacle is prone to gas leaks.

The alerts are typically displayed on the control system user interface, which is in communication with the control system data processor, either through a direct or wireless connection. The control system user interface may be any suitable user interface, such as a computer screen or graphical user interface, which may be configured to display information about the gas, gas receptacles, operators handling the receptacles, and transaction data and may also be configured to display past transaction data also.

Where the control system generates an alert that a leak has been identified, the alert may include information about the leak, such as the volume of gas leaked, the rate of the leak, and the receptacle from which the gas has leaked. Optionally, the alert may also provide information relating to: the type of receptacle (such as whether the receptacle is a gas cylinder or circuit breaker); the location and/or owner of the gas receptacle; the approximate time of the gas leak; whether the leak is likely to be as a result of incorrect handling by an operator or as a result of a faulty gas receptacle; and/or identification information relating to the operator(s) handling the gas receptacle(s) that is/are leaking. The same alert or a separate alert may also provide the estimated date and time at which the receptacle will reach a lock out state. In one form, the control system is programmed so that a lock state alert is only provided where gas is leaking from a circuit breaker. Where the gas management system is used to manage more than one type of gas, the alert(s) may also include information that identifies the type of gas that has leaked or that is leaking.

The control system storage medium is configured to store historical gas management data that comprises historical gas transaction data and historical data relating to identified gas leaks and alerts. In one form, the control system is configured so that, over time, it is able to identify: the performance of each gas receptacle, the performance of different types of gas receptacle; the performance of different companies managing gas receptacles; and/or the performance of operators conducting gas transactions. The historical data itself may be used by the control system to determine when further alerts should be generated. For example, as mentioned above, the control system may be programmed to generate an alert when the historical gas management data indicates that a particular gas receptacle or a particular type of receptacle is prone to gas leaks and may require servicing or replacement. For example, if the control system identifies that a particular receptacle or type of receptacle has been linked with a predetermined number of gas leaks within a predetermined time period, the control system may generate an alert that the particular receptacle or all receptacles of that type need to be repaired or replaced. Similarly, an alert may be generated when receptacle ID 1234, for example, has experienced more than x number of gas leaks or has experienced gas leaks totaling more than y % of gas loss within a predetermined time period.

In another form, the control system may be programmed to identify poor operator handling and to generate an alert when the historical gas management data indicates that a particular operator is commonly associated with gas leaks and may require further training. For example, the control system may have identified that x number of gas leaks occurred within a predetermined time period where each of those gas leaks were linked with gas transaction operations conducted by operator ID Smith.

It is possible for the system to identify leaks associated with a particular operator because, once the volume of gas transferred in gas transaction is calculated, the gas measurement system can determine the mass of gas required to be added to or removed from a receptacle for the receptacle to reach a desired working pressure of a predetermined value or within a predetermined range. The gas measurement system may be configured to communicate the mass calculation to the control system as gas transaction data. The control system then compares the mass calculation with the volume of gas that was actually transferred to determine if the operator used more or less gas than that which was required to reach working pressure. If the operator uses more gas, the control system identifies that the operator may have caused a gas leak, which may be in the form of a gas emission during handling. Alternatively, the gas measurement system may calculate the volume of gas actually transferred and the gas measurement system processor may be programmed to determine if the operator used more or less gas than that required. If the operator has used an incorrect amount of gas, the gas measurement system may communicate this to the control system as transaction data. The control system may then generate an alert that the particular operator used too much or too little gas when handling that receptacle. The control system may be programmed to provide as much or as little information about the handling error as the user requires. For example, the control system may provide information identifying the operator, the receptacle, the location of the receptacle, the time and date of the transaction, whether too much or too little gas was used, the volume of the gas discrepancy and/or any other information that may be useful to the system user. Therefore, the control system may be configured so that when a leak is detected, an alert may be generated to show that the leak is the result of an equipment leakage emission or a handling emission.

In one form, the gas measurement system may comprise scales for weighing a receptacle to determine the quantity of gas held within a receptacle. Typically, the weight of the receptacle alone (without gas) is known, so that it is possible for the gas measurement system processor or control system processor to calculate the quantity of gas held in the receptacle by comparing the known receptacle weight with the weight of the receptacle containing gas. The scales may also be used to weigh a receptacle before and after a gas transaction. For example, an operator may weigh a receptacle before a gas transaction to obtain an initial weight of the receptacle. This initial weight is recorded by the gas measurement system and may be held in its memory or transmitted to the control system. The operator also weighs the receptacle after the gas transaction. This subsequent weight is also recorded by the gas measurement system and may be held in its memory or transmitted to the control system. In one form, the gas measurement system processor is programmed to compare the initial and subsequent weights of the receptacle to calculate the mass of gas added to or removed from the receptacle. The mass calculation is then compared with the volume of gas transferred to determine whether any gas has leaked during the transaction. The weight and mass measurements and data identifying a likely leak may be transmitted to the control system or may be stored in memory and communicated to the control system at a later date. In one form, the weight and mass measurements are communicated to the control system with other gas transaction data, as mentioned above, and the control system is programmed to compare the initial and subsequent weights of the receptacle to calculate the mass of gas added to, or removed from, the receptacle. The mass calculation is then compared with the volume of gas transferred to determine whether any gas has leaked during the transaction. If a leak has occurred, the control system may generate an alert, which may include: the time of the leak; the location of the leak; the receptacle ID; the operator ID; and/or any other information that may be useful to identify and respond to the leak.

### Control System User Interface

Past and present gas transaction data, alerts, and any information associated with alerts may be stored in the control system storage medium or memory, preferably in the form of a database. The control system may be configured to delete data from its memory after a predetermined period of time and/or the system may be configured to allow manual deletion of data by a user. The data may be displayed on the control system user interface in any suitable format for a user to interpret, so that gas movements, including leaks/losses, can be monitored. In one format, the data is displayed in a spreadsheet-like format that may be configured to provide information relating to any one or more of the following:
The location of a gas receptacle
The receptacle ID
The type of receptacle
The owner of the receptacle
The operator handling the receptacle
The operator competencies
Dates of when those competencies expire.
The operator employer
The type of gas transaction (gas input or gas output from the receptacle)
The date and time of gas transaction
The mass of gas transferred
The temperature
The start pressure
The end pressure
The desired working pressure
The density of gas transferred
The volume of gas transferred
Any gas leak alerts relating to the receptacle, operator, or gas transaction operation
The rate of gas leaks identified
The estimated time that a leaking receptacle will reach the lock out state
Any other information helpful to the user

### Example Scenario 1

In an example of use of one form of the invention, an operator is assigned to remove SF₆ gas from a circuit breaker. The gas flow meter of the gas measurement system is connected to the circuit breaker via a hose and then to gas removal equipment to remove the SF₆ gas from the circuit breaker into a gas cylinder. Data is entered into the gas measurement system via the user interface. The data may be the operator name, circuit breaker ID, make and model, and cylinder ID. The gas measurement system may be used to measure the start pressure and ambient temperature of the circuit breaker. In one form, these measurements may be automatically recorded by the gas measurement system or the operator may enter the measurements through the user interface. The gas flow meter is then started and the gas removal equipment is started to remove the SF₆ gas from the circuit breaker. Once the desired pressure of the gas cylinder is reached (for example transport pressure of 1,3 Bar absolute), the gas removal equipment is stopped and the gas flow meter is also stopped. The gas measurement system is then used to measure the finishing pressure and temperature of the circuit breaker. Again, the system may be configured to record these measurements automatically or they may be entered into the system via the user interface. The gas measurement system may also record the amount of gas (in kg's) that was transacted. This latest transaction data is transferred to the control system, which logs the transaction and compares the data to existing information recorded for the gas cylinder and circuit breaker. The control system analyses differences between the latest transaction data and the existing data for the receptacles to determine whether any emissions of SF₆ gas are likely to have occurred or whether any gas is likely to have been retained within the gas removal equipment.

Using data from the gas measurement system and data that is input by an operator, the gas management system can identify gas stocks held by certain companies and can also identify where those stocks are held and the quantities in which they are held.

Over time, the system will be able to identify the performance of each gas receptacle, types of receptacle, and/or the performance of individual gas operators. As the transaction data is uploaded to the control system over time, an increasingly accurate picture of gas usage may be obtained. For example, the gas management system may be used to record substantially all gas transaction data from the original installation of a receptacle to its final decommissioning and removal.

The gas management system may provide a useful tool to monitor the usage of a gas, such as SF₆, to ensure reliable reporting and to keep track of the quantity of the gas transacted within a facility or region or even across the country.

The foregoing description of the invention includes preferred forms thereof. Modifications may be made thereto without departing from the scope of the invention. For example, although preferred forms of the invention have been described herein in relation to gas movement into and out of gas cylinders and circuit breakers, it should be appreciated that the invention is intended to be used with any suitable gas receptacle.

Also, the embodiments may be described as a sequential process, many of the operations can be performed in parallel or concurrently. In addition, the order of some operations may be rearranged. A process is terminated when its operations are completed. A process may correspond to a method, a function, a procedure, a subroutine, a subprogram, etc., in a computer program.

Embodiments of the invention may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the foregoing, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, and/or various other mediums capable of storing, containing or carrying instruction(s) and/or data.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or software algorithms described in connection with the examples disclosed herein may be embodied directly in hardware, in a software module executable by a processor, or in a combination of both, in the form of a processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated in the FIGURES may be rearranged and/or combined into a single component or embodied in several components without departing from the invention. Additional elements or components may also be added without departing from the invention. Additionally, the features described herein may be implemented in software, hardware, as a business method, and/or combination thereof.

In its various aspects, the invention can be embodied in a computer-implemented process, a machine (such as an electronic device, or a general purpose computer or other device that provides a platform on which computer programs can be executed), processes performed by these machines, or an article of manufacture. Such articles can include a computer program product or digital information product in which a computer readable storage medium containing computer program instructions or computer readable data stored thereon, and processes and machines that create and use these articles of manufacture.

1. A gas management system comprising:
a. at least one gas measurement system comprising a flow meter to measure gas flow into and out of at least one receptacle to provide gas transaction data; and
b. a control system configured to receive the gas transaction data, wherein the control system is also configured to analyse the gas transaction data to identify a gas leak from the at least one receptacle; and to determine the rate of the gas leak, when identified.

2. The gas management system of claim 1, wherein the control system is configured to forecast the time and date of when a leaking receptacle will reach the lock out state.

3. The gas management system of claim 1, wherein the control system comprises or is connected to an alarm that provides an alert when the control system forecasts a lockout state.

4. The gas management system of claim 1, wherein the control system comprises a database that records:
a. the gas transaction data for each gas receptacle.

5. The gas management system of claim 4, wherein the database records:
a. the make, model, serial number, function, rating, nameplate information, installation date, and/or location of each gas receptacle monitored by the gas management system.

6. The gas management system of claim 4, wherein the database records information identifying the operator handling each gas receptacle and the dates on which each gas receptacle was handled by that operator.

7. The gas management system of claim 4, wherein the database records the owner of one or more gas receptacles monitored by the gas management system.

8. The gas management system of claim 1, wherein the control system is configured to calculate the accurate volume of a receptacle.

9. The gas management system of claim 1, wherein the system comprises a dew point meter to measure the moisture content of the gas and wherein the gas transaction data includes data relating to the moisture content of the gas.

10. The gas management system of claim 1, wherein the gas measurement system comprises a user interface through which an operator may input any one or more of the following:
a. an operator ID;
b. a receptacle ID;
c. any other details identifying the operator and/or receptacle being handled.

11. The gas management system of claim 1, wherein the control system is configured to identify the types of gas receptacles for which a predetermined number of gas leaks have occurred within a predetermined time period and to provide an equipment alert indicating that these types of receptacles may be prone to gas leaks.

12. The gas management system of claim 1, wherein the control system is configured to identify any operators handling gas receptacles for which a predetermined number of gas leaks have occurred within a predetermined time period and to provide an operator alert indicating that this/these operator(s) may need further gas handling training.

13. The gas management system of claim 1, wherein the gas measurement system comprises a fixed or removable storage medium for storing gas transaction data.

14. The gas management system of claim 13, wherein the gas measurement system is configured to receive a USB stick.

15. The gas management system of claim 13, wherein the gas measurement system comprises a fixed storage medium and a transmitter for transmitting gas transaction data to the control system or to an external storage device.

16. A method of managing gas in one or more receptacles; the method comprising:
measuring the mass of gas into at least one receptacle and subsequently measuring the mass of gas out of the at least one receptacle with a gas flow meter;
providing the measurements to a control system as gas transaction data;
receiving and analyzing the gas transaction data in the control system to identify if a gas leak has occurred from the at least one receptacle; and
calculating the leak rate of gas from the at least one receptacle and determining when the receptacle will be emptied of gas if the leak continues.

17. The method of claim 16, wherein the gas transaction data is stored on a storage medium connected to the gas measurement system before the gas transaction data is communicated to the control system.
